(19) United States
(12) Patent Application Publication
(10) Pub. No.: US 2007/0168268 A1
(43) Pub. Date: Jul. 19, 2007

(54) Mortality put options and methods, systems, and products for providing same

(76) Inventors: Jeffrey S. Lange, New York, NY (US); Jonathan M. Lewis, New York, NY (US)

Correspondence Address: Mr. Jeffrey S. Lange;Generation Advisors, 34th Floor, 226 W. 52nd Street, New York, NY, 10019, US

(21) Appl. No.: 11/330,939

(22) Filed: Jan. 13, 2006

(51) Int. Cl. G06Q 40/00

(52) U.S. Cl. 705/36 R

(57) ABSTRACT

This invention provides systems, methods, and designs for a novel financial product which provides many lifecycle investment advantages compared to existing state of the art products currently available.

### FIELD OF THE INVENTION

The present invention relates generally to systems, methods, plans and products for designing and providing investment products which are both investment and tax efficient across the lifecycle of an individual. In the theory of financial economics, lifecycle investing involves systematic investment planning throughout an individual's entire lifecycle in order to help best achieve one's financial objectives and goals. According to the well known Lifecycle Investment Theory of Nobel laureate Franco Modigliani, every individual passes through distinct stages in his lifecycle which are defined by characteristic and differing marginal utilities for saving and consumption. The first characteristic stage is the accumulation phase, during which an individual has higher marginal utility for consumption but constrained or limited resources. This phase is marked by dissaving by the individual, as he spends more by way of loans than he earns to meet his multiple needs. The second characteristic phase in an individual's lifecycle is the consolidation phase wherein the individual has satisfied most of his essential needs and is looking at opportunities of incremental wealth generation. This phase is marked by a higher marginal utility of wealth currently or, in other words, an intertemporal substitution of consumption whereby deferred consumption is deemed to have higher utility. In this stage, individuals typically exhibit net saving. The third and fourth phases are often referred to as the spending and gifting stages, respectively. These phases are again marked by dissaving as an individual eats into his earlier savings to meet up with his remaining lifecycle. As an individual evolves through these stages in his lifecycle, not only do his financial objectives and goals change, but also his risk bearing ability, which largely determines the feasible set of investment choices at each stage. The aim of the present invention is to provide novel methods, systems and products for lifecycle investment which efficiently achieve these changing investment goals. Throughout the description of this invention the term efficiency includes both market or pure investment efficiency which is a function of the expected returns and volatilities of the feasible set of investment choices, and tax efficiency, which refers to providing investment methods, systems, and products which produce a large after-tax source of wealth under the U.S. Internal Revenue Code.

### BACKGROUND OF THE INVENTION

A number of uses for life insurance products have emerged in recent years to fulfill many lifecycle investment objectives. Various types of life insurance have a dual savings and bequest objective which reflect the demand for deferred consumption in one's own lifetime and for the lifetime of one's beneficiaries. Recent innovations, such as variable universal life (VUL) insurance, bundle investment accounts together with yearly renewable term insurance. In this product, individuals may invest in a range of securities, mutual funds, or other types of investment partnerships in segregated investment accounts. The accounts are nominally owned by the issuing life insurance company. As a consequence, the owner of a variable universal life insurance policy pays no current income tax on investment returns. The death benefit of a VUL policy will generally increase as positive investment returns are accumulated. If the individual dies, this increased death benefit is paid out free of income tax to the VUL policy's beneficiaries. If the owner of the policy makes a withdrawal from the VUL policy prior to death, ordinary income tax is due on any earnings in the policy. Thus, a VUL policy bundles together the following components: (1) tax preferred growth of assets for either the individual (tax deferred withdrawals) or the individual's beneficiaries (tax free death benefits); (2) a layer of yearly renewable term insurance which is responsive to the overall growth in the investment accounts; (3) a mechanism by which the layer of term insurance can be paid for with before tax dollars through automatic deductions in the investment accounts.

A VUL policy is therefore a bundle of what financial economists call contingent claims. A pure contingent claim is a non-interest bearing security which pays out a unit of account (i.e., a dollar) should a given state of the world occur. For example, pure term life insurance pays out a certain quantity of dollars upon the death of an individual. Financial economists generally recognize that it is preferable to have a complete set of elementary (i.e., unbundles) contingent claims from which individuals can choose to fulfill their lifecycle investment objectives. (See, e.g., Lange and Economides, “A Parimutuel Market Microstructure for Contingent Claims,” European Financial Management, vol. 11:1 Jan. 2005, and references cited therein). It is also generally recognized that bundling of contingent claims is generally a redundant exercise, however, bundling may be advantageous due to transaction cost and tax efficiency. For example, a VUL policy is a bundling of a tax deferred investment account and a term life insurance policy. An individual might be able to achieve the same objectives satisfied by a VUL policy by investing in a tax deferred 401(k) account and buying yearly renewable term insurance. Prima facie, the combination of the 401(k) and the term insurance appears to achieve the same objectives as the VUL policy: tax free accumulation of investment returns available for withdrawal at a future date and an income tax free death benefit for beneficiaries. However, the VUL policy dominates for two reasons. First, were an individual to attempt to replicate a VUL policy with a 401(k) account and yearly renewable term insurance, they would find that the premiums paid on the term insurance must be made from after tax dollars. Section 264 of the Internal Revenue Code provides that these premiums are not tax deductible. In the VUL policy, by contrast, the premiums which keep the insurance portion of the VUL policy in force are automatically deducted on a monthly basis from the investment account. To the extent the investment account has returns, the premiums for the insurance are paid with pre-tax dollars since the returns from the VUL policy investment accounts accrue free of income tax. Second, replicating the VUL policy with a 401(k) and yearly renewable term insurance will incur significant transaction costs as the individual must dynamically “rebalance” the ratio of the balance in the 401(k) versus the amount of term insurance. The VUL policy does this type of rebalancing automatically according to well-known and relatively efficient procedures. There is, however, a cost to bundling in the VUL policy: the Internal Revenue Code requires a minimum ratio of insurance to the balance in the VUL investment account in order for the VUL policy to meet the definition of insurance under Title 26, Section 7702. If this minimum ratio is requirement is not met, then the investment account returns will not receive the benefit of tax-free accumulation and the death benefit will be free from income tax.

In the spending and gifting phases of the lifecycle investment theory, an individual would typically optimally reduce his exposure to the riskiest of asset classes and, at some later point in his lifecycle, begin to annuitize a large portion of his wealth. The portion of assets exposed to risky assets classes, the level of such risk, the amount of wealth annuitized largely depend upon the individual's utility for current consumption and his utility for estate preservation—what economists typically call a “bequest motive” since it refers to a utility function “beyond the grave” to preserve assets for the next generation via bequest (or, equivalently, gifts late in an individual's lifetime). While a VUL policy can allow an individual to reallocate away from risk assets at this state in life and also annuitize part of his wealth, a VUL product's death benefit and the performance of its underlying investments are highly correlated. That is, if the segregated account assets of a VUL policy fail to perform adequately, there may not be sufficient funds in the VUL policy to keep the death benefit in force through ongoing payments of the policy's cost of insurance. It is therefore an aim of the present invention to provide a lifecycle investment product in which (1) an investor can maintain a higher allocation to risky assets later in life and (2) provide protection to such assets in the event of death. In the present invention, such a product is termed a “mortality put option” (or, simply, “mortality put”), since the product allows the individual to sell risky assets, at predetermined prices, to the issuer of the mortality put but only upon the death of the individual.

In practice, one cannot currently purchase a mortality put option which gives the purchaser of the put option to sell assets, such as the S&P500 Index, at a predetermined price upon the death of the holder. In the capital markets, only short dated options, perhaps extending out only several years are available, and, where available, are only available on a narrow class of indices. In addition, the longer dated products have large transaction costs. Furthermore, no product offered in the current capital markets—which would include OTC derivatives and other products offered by investment banks and broker dealers and the recognized futures and options exchanges such as the Chicago Mercantile Exchange—offer any options which are exercisable upon the death of the holder which thereby provides a lifecycle investment options to the purchaser. Likewise, while the life insurance industry offers a variety of life insurance and annuity contracts, none can be said to perform the vital function and fill the need for the mortality put described in the present invention. For example, were an individual to purchase life insurance on his own life to fund any potential future losses on his portfolio of risky assets, such a purchase would not replicate the most desirable features of the mortality put option. First, the individual would need to pay for the policy in order to hedge his risky assets and other potential estate liabilities which arise upon his death. A sizeable policy could cost many hundreds of thousands of dollars a year and more to keep in force. Even with such a commitment, if the individual lives for many years the investment in the life insurance will prove to have been a bad one in terms of internal rate of return. Furthermore, if the risky assets to be insured or other liabilities do not materialize (such as the elimination of estate tax liabilities) all of the premiums invested in the policy will not have been used efficiently. Second, the performance of the policy is not tied directly to the risky asset's performance as is a mortality put. The mortality put provides the purchaser a positive cash flow upon death—hence into the estate of the now deceased purchase—should the risky asset or assets upon which the put was issued fall below a certain level. By contrast, the death benefit or insurance feature of a variable life insurance contract is highly correlated to the performance of the risky assets invested in the variable life contract. The poorer the performance of such assets inside the variable life insurance segregated account, the lower the death benefit. In fact, very poor performance may mean that there are not sufficient funds in the variable life policy to maintain the policy's death benefit in force, an outcome for which the mortality put has its greatest, rather than worst, performance. Third, the risk which a mortality put is meant to address cannot be hedged by the usual means using traditional financial instruments. Thus, a seller of a mortality put on the S&P500, for example, would find it difficult to hedge both the long dated nature of the option and also its stochastic exercise upon the death of the individual. For all these reasons and others, there is a need for a financial instrument called a mortality put option which, in a preferred embodiment, has the following characteristics:
(1) a payout which is (a) a derivative of a risky asset such as equity (e.g., SP500, Dow30), real estate (e.g., REIT indices), and commodity indices;
(2) is exercisable upon death and, in a preferred embodiment, is only exercisable upon death;
(3) in a preferred embodiment has a premium or purchase price which is contingent upon the mortality of the purchaser upon expiring in the money and payable, in a preferred embodiment, by the purchaser's estate upon death in the event the option is in the money (“a contingent premium mortality put”);
(4) can be hedged, by the seller of the mortality put, through the original purchase of life insurance on the life or lives of the buyer of the mortality put

In a preferred embodiment, a contingent premium mortality put (“CPMP”) is a financial instrument which is characterized by the following cash flows:
At time t: P
At time \tilde{T}: If K>S_{\tilde{T}} then K−S_{\tilde{T}}−CP_{ITM}
If K≦S_{\tilde{T}} then−CP_{OTM}
where
K=the mortality put option strike price
S_{\tilde{T}}=the price of the risk asset at time \tilde{T}
t=the time of option purchase
P=the premium paid for the option at time of purchase
\tilde{T}=the time of death, a random variable
CP_{ITM}=the in-the-money contingent premium, fixed at time of purchase
CP_{ITM}=the out-of-the-money contingent premium, fixed at the time of purchase

### SUMMARY OF THE INVENTION

The present invention provides methods, systems and products to solve the following problems or deficiencies facing an individual who desires to use insurance and investment products to meet lifecycle objectives:
(1) Current products, such as variable universal life insurance, require relatively large amounts of pure life insurance per dollar of investment account in order to comply with the Internal Revenue Code's definition of life insurance;
(2) Current VUL products have a variable segregated account which is used to fund the life insurance benefit (net amount at risk). To the extent the risky assets in the variable account underperform, the death benefit may be reduced or lapsed;
(3) Current insurance products including VUL products do not provide the purchaser with an efficient means of protecting their risky assets over long actuarial periods covering the individual's full lifecycle to mortality;
(4) Currently available capital markets products such as futures and options do not provide the purchaser with an efficient means of protecting risky assets over long actuarial periods covering the individual's full lifecycle to mortality;
(5) Current insurance products do not offer a mortality put option whereby the purchaser of such a put option acquires the right to sell, at a predetermined strike price, a predetermined quantity of risky assets to the seller of the put upon the death of the purchaser;
(6) Currently available capital markets products do not offer a mortality put option whereby the purchaser of such a put option acquires the right to sell, at a predetermined strike price, a predetermined quantity of risky assets to the seller of the put upon the death of the purchaser.

The aim of the present invention is to solve these problems by providing methods, systems and products which accomplish these investment and insurance objectives.

A need is recognized for a new investment product which provides a lifecycle hedge to the death of the purchaser which, among other things, allows the purchaser to hold greater quantities of risk assets or bear greater risk later in his investment lifecycle.

A need is recognized for a new investment product which provides a payout upon the death of the insured should a specified risky asset class, such as the S&P500, fall below a given level at the time of the purchaser's death.

A need is recognized for a lifecycle investment product called a contingent premium mortality put.

A need is recognized for a new investment product called a contingent premium mortality put which (a) does not require the purchaser to pay any consideration at the time of purchase; (b) allows the purchaser to sell a risky asset class upon death at a predetermined strike price; and (c) subtracts the option premium for the put out of the settlement proceeds of the option upon the death of the purchaser.

A need is recognized for a new investment product called a contingent premium mortality put which can be efficiently hedged by the seller of the put with life insurance policies written on the lives of the purchasers.

According to one embodiment of the present invention, as described herein, a method, system and product for a contingent premium mortality put option comprises the steps of:
1) determining a candidate for the purchase of the contingent premium mortality put option based on a plurality of criteria;
2) selecting a plurality of risk asset classes upon which the contingent premium mortality put will be written such as the S&P500, Dow 30, NASDAQ 100, CSFB Tremont Hedge Fund Index, the Morgan Stanley EAFE Index, and others;
3) determining the purchase premium and contingent premium of the contingent premium mortality put;
4) obtaining the consent to purchase life insurance on the life of the purchaser of the contingent premium mortality put for the benefit of the seller;
5) determining the amount of life insurance to be purchased by the seller to collateralize and hedge the obligations to the purchaser under the contingent premium mortality put as a function of (a) the amount of risk assets to be sold under the put option; (b) the strike price of the put option; and (c) the contingent premium of the put option;
6) having the seller of the contingent premium mortality put option purchase life insurance upon the life (or lives) of the option purchaser from a plurality of carriers whereby such life insurance may be (a) general account universal life insurance (b) variable universal life insurance (c) term life insurance or (d) other types of life insurance such as whole life insurance;
7) having the seller of the contingent premium mortality put option create a bankruptcy remote special purpose entity (“SPE”) which (a) is the counterparty to the option purchaser and (b) holds the life insurance and other assets which collateralize or hedge the liabilities to a plurality of option purchasers.

### BRIEF DESCRIPTION OF THE DRAWINGS

FIG. 1 is a schematic representation of a system, method, and product for the CPMP—a contingent premium mortality put option which provides lifecycle protection for the purchaser's risk assets.

FIG. 2 is a schematic representation of a system, method, and product for the management of a portfolio of life insurance assets used to collateralize or hedge CPMP obligations.

### DETAILED DESCRIPTION

The present invention is described in relation to systems, methods, products and plans for the enablement of a novel lifecycle financial contract and product. The product, described above and named CPMP for the purposes of the present invention, is a novel put option which provides the following benefits: (1) provides the purchaser with lifecycle protection for risky asset classes through the mortality of the purchaser by allowing the purchaser to specify (a) one or more risky asset classes upon which the put option is to be written; (b) consent to the purchase of life insurance by the seller of the CPMP so that the seller's obligation under the life insurance policies can be funded, collateralized and hedged; (c) select a predetermined strike price and quantity of such assets to be subject to the CPMP; and (d) determination of the contingent premium to be netted out of settlement proceeds of the CPMP upon the death of the purchaser.

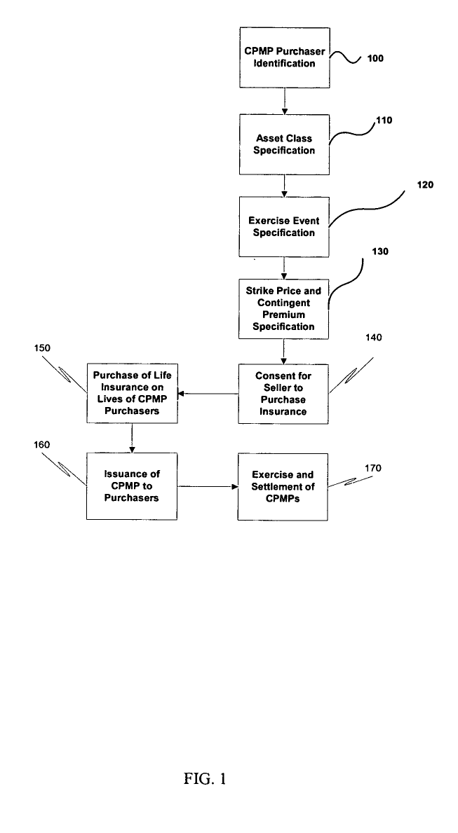

FIG. 1 is a schematic representation of a system and method for the creation of the CPMP product, and a schematic illustration of the product itself. The system, method, or product, 100, may comprise the ability to identify suitable purchasers. Suitable purchasers are those that might be of a certain age, insurable status, have sufficient net worth for insurance purposes and meet other criteria such as being accredited investors (income and net worth requirements for regulatory purposes). Additionally, the identification of likely CPMP purchasers may include the analysis of a prospective purchasers current portfolio holdings or potential holdings of risky assets, an analysis of their present and future tax liabilities, and their bequest motives for their heirs (i.e., an analysis of their utility function for leaving large amounts of wealth to heirs). Referring again to FIG. 1, step 110 comprises the identification of the risky asset or assets upon which the CPMP will be written. In a preferred embodiment the risky asset classes will comprise a known and standardized set of investable benchmarks, such as the S&P500 index, the DOW 30 index, the CSFB Tremont Hedge Fund Index, and the Dow Jones Wilshire REIT Index. In another preferred embodiment, the specified asset class could be individual securities, such as shares of IBM. For example, a suitable purchaser of a CPMP might be the founder or executive of a company who has a substantial ownership interest in his company's stock. The CPMP would provide entire lifetime protection for such a stock ownership position with, in a preferred embodiment, no upfront consideration paid by the purchaser at the time of purchase.

Referring again to FIG. 1, step 120 comprises the specification of the exercise boundary of the CPMP. In quantitative finance, the term exercise boundary refers to the set of conditions under which an option may be exercisable. For example, a European option is exercisable only upon a predetermined fixed date—the expiration or maturity date of the option. An American option, by contrast, is exercisable at any time up to the expiration date. Still other types of options, such as Bermudan options, may be exercisable at specific dates prior to the expiration date of the option. Expiration dates may be stochastic as well in that they depend upon the value of some random variable in the future. For example, an option on the S&P500 may become exercisable if the value of the S&P500 index attains a certain value. In a preferred embodiment, the CPMP may be exercisable only upon the death of the purchaser of the CPMP. For example, say the purchaser of the CPMP is a high net worth individual who is a 65 year old male. In addition, assume that, for example, the CPMP gives the right for this individual to sell $15,000,000 of the S&P500 Index to the seller of the CPMP upon the death of the purchaser (the 65 year old male). IF the value of the S&P500 Index at the time of the individual's death is only $10,000,000, the individual would be entitled to the difference between the selling price of $15,000,000 and the current value of $10,000,000, less the contingent premium (discussed further below). If the contingent premium established at the time of purchase were equal to $2,000,000, then the individual would be entitled to $3,000,000 at the time of his death. In another preferred embodiment, the exercise event could be specified as second death of two individuals, such as a husband and spouse. Or the exercise event could be the fist death of several individuals, such as business partners. Those of ordinary skill in the art will recognize that many different combinations of contingent events involving mortality are possible exercise events for a CPMP.

Referring again to FIG. 1, step 130 is the method which determines the strike price and contingent premium (CP) of the CPMP. Recalling the cashflows of a CPMP using mathematical notation:
At time t: P
At time \tilde{T}: If K>S_{\tilde{T}} then K−S_{\tilde{T}}−CP_{ITM}
If K≦S_{\tilde{T}} then−CP_{OTM}
where
K=the mortality put option strike price
S_{\tilde{T}} the price of the risk asset at time \tilde{T}
t=the time of option purchase
P=the premium paid for the option at time of purchase
\tilde{T}=the time of death, a random variable
CP_{ITM}=the in-the-money contingent premium, fixed at time of purchase
CP_{ITM}=the out-of-the-money contingent premium, fixed at the time of purchase

Reviewing the mathematical notation, at the time of purchase (small “t”), the premium P for the CPMP may be paid. In a preferred embodiment, the value of P can be set to zero which means that no consideration or cash is transacted at the purchase of the option. This can be very attractive from the perspective of the purchaser who might have a high value for liquidity at the time of purchase. In yet another preferred embodiment, the value of P might be positive or negative. If negative, the purchaser of the option may actually receive cash up front at the time or purchase. This is a novel featured of the CPMP since it is usually the case that the purchaser of the option pays cash to the seller rather than receives cash from the seller. At the time of exercise (big “I”) which is a random variable since, in a preferred embodiment the time of exercise is the random time of death of the purchaser, the CPMP is settled. As is described in the mathematical notation above, at the time of the purchaser's death the CPMP will either be in the money or out of the money. The CPMP is in the money if the value of the underlying risky asset is less than the strike price. When the CPMP is in the money, the purchaser receives the difference between the strike price and the underlying value of the risky asset, less the in the money contingent premium (CP_{ITM}). When the CPMP is out of the money (value of the asset greater or equal to strike price at mortality), then the purchaser may pay an out of the money contingent premium. In a preferred embodiment, the value of P and the out of the money contingent premium are set equal to zero, so that the only premium to be solved for at the time of purchase is the in the money contingent premium. An advantage of this embodiment is that the purchaser of the option pays no up front consideration at the time of purchase.

The strike price of the option, according to FIG. 1 step 130, is determined by consulting the needs of the purchaser, the nature of the risky index upon which the CPMP is written, the age of the purchaser and other factors. For example, if the age of the purchaser is quite advanced, it may be less than desirable to make the strike price very high. On the other hand, for younger purchasers, a higher strike price might be required. In any event, for a given strike price, in a preferred embodiment, the in the money contingent premium is solved for so that the discounted expected value of the payout of the CPMP at the date of mortality is equal to zero. For simplicity, assume that the initial premium, P, and the out of the money contingent premium are set to zero. The problem of solving for the in the money contingent premium is as follows:

$${arg solve}_{{CP}_{ITM}} {\sum }_{t = 0}^{t = T} Z ( 0 , t ) E ( K - {S}_{t} - {CP}_{ITM} ) = 0$$

where
Z(0,t) =the present value of a dollar received at T at time 0.

As will be described in greater detail below, the in the money contingent premium can be solved for using relevant actuarial data and Monte Carlo simulation techniques. The in the money contingent premium amount is considered actuarially fair when it favors neither the purchaser nor seller on a discounted expected value basis. For example, for a 65 year old male, with initial spot price of the risk asset equal to 100 (S(0)=100) and strike equal to 150, the in the money contingent premium that solves the above problem might, for a given set of probabilities describing the death rate of the individual over his remaining possible lifetime, might be equal to 20. Therefore, for example, if upon the individuals' death the risky asset is only worth 80, the deceased purchaser's estate will receive 150-80-20 or a payment of 50 per each 100 of risky asset subject to the CPMP.

Referring again to FIG. 1, step 140 provides the consent by the CPMP purchaser for the CPMP seller to purchase life insurance upon the life of the purchaser. As the CPMP creates a potential and sizeable liability to the CPMP seller upon the death of the CPMP purchaser, the seller of the CPMP has an “insurable interest” for purposes of life insurance acquisition on the life of the purchaser (or whomever's life is the reference for the exercise event of the CPMP). The insurable interest of the seller in the life of the purchaser of the CPMP is conferred under state law in the United States. As an example, under the Insurance Code of the State of California, Section 10110.1(a):

“An insurable interest, with reference to life and disability insurance, is an interest based upon a reasonable expectation of pecuniary advantage through the continued life, health, or bodily safety of another person and consequent loss by reason of that person's death or disability or a substantial interest engendered by love and affection in the case of individuals closely related by blood or law.”

Clearly, the writer or seller of the CPMP only has to pay the purchaser upon the purchaser's death and therefore has a “pecuniary advantage through the continued life” of the purchaser and a “consequent loss by reason of [the purchaser's] death” under the statute. Similar statutory language exists in all of the other states in the United States which would confer original insurable interest in the seller of the CPMP so that, with the consent of the CPMP purchaser, the seller could directly purchase a life insurance policy on the life of the CPMP purchaser. Because of the existence of such insurable interest in favor of the seller, the seller could name himself (or itself) as owner and beneficiary in a preferred embodiment per step 150 of FIG. 1. An additional advantage of the present invention is that as a bona fide original purchaser of the life insurance, the seller will receive death benefits under the U.S. Tax Code Section 101(a) free from income tax. The tax-free nature of the life insurance policies which are used to fund or hedge the obligations under the CPMP increase the efficiency of the pricing and hedging of the CPMP dramatically so that the CPMP's can be made very attractive to the purchasers.

Referring again to FIG. 1, step 160 is the actual issuance of the CPMP's to the purchaser or purchasers once the underlying life insurance policies have been purchased. In a preferred embodiment, the life insurance policies will be originated and owned inside a special purpose entity (“SPE”) which is bankruptcy remote so that the benefits under the policies can be used to satisfy the obligations under the CPMPs sold to respective purchasers. The bankruptcy remote entity holds the life insurance policies to hedge the unique mortality related timing risk of the obligations created by the CPMP's. In an preferred embodiment, the SPE may also engage in transactions which hedge the underlying risky asset such as by buying put options or “delta hedging.” In yet another preferred embodiment, the SPE will purchase life insurance on each purchaser equal to K+CP_{ITM} to hedge the worst case scenario arising from the value of the risky asset going to zero coincident with the death of the insured in which case the seller of the CPMP would owe the purchaser's estate the amount of the strike price less the contingent premium. In other cases where the CPMP is just in the-money, the seller will be owed the contingent premium and will therefore need to collect this amount from the deceased purchaser's estate. In order to hedge the credit risk of the estate, the seller of the CPMP may instead buy additional life insurance equal to the contingent premium amount (CP).

In a preferred embodiment, the CPMP is exercised upon the death of the purchaser or other individual as described in the CPMP instrument. In 170 of FIG. 1, the settlement of the CPMP involves determining (i) whether the CPMP is in the money; and (2) settling the CPMP by paying the purchaser any in the money amounts less the in the money contingent premium. The settlement may either be cash settled or settled through the actual sale of the risky asset to the seller of the CPMP. In a preferred embodiment, another advantage of the CPMP is that the estate of the purchaser should not have any income tax on any gains in the CPMP due to the step up basis rule. As the CPMP will have approximately the same intrinsic value just after the purchaser's death as just before the purchaser's death, the basis of the CPMP should “step up” to the intrinsic value, meaning that the purchaser's estate will have a basis in the CPMP approximately equal to the settlement proceeds. Thus, the CPMP will be as tax efficient as the payment of a life insurance death benefit, i.e., no income tax will be assessed.

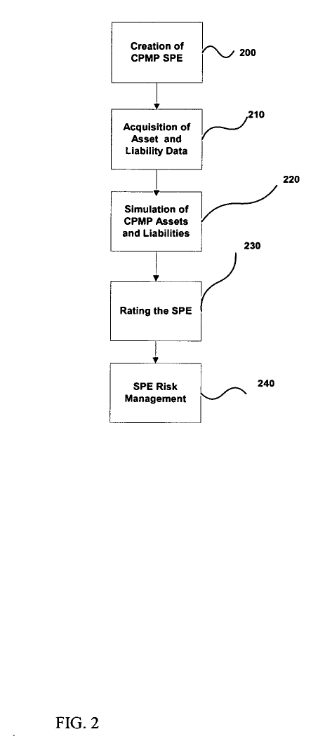

Referring now to FIG. 2, there is described the methods and systems for the management of the CPMP liabilities and funding or hedging assets. Step 200 of FIG. 2 comprised the forming of a bankruptcy remote limited liability corporation, C Corporation, asset securitization trust or similar entity. Such entity must be adequate to (i) receive a capital investment to initially support the acquisition of the CPMP contingent liabilities (i.e., put option liabilities); (2) be bankruptcy remote and protected from any creditors other than the CPMP obligees; (3) be suitable for issuing additional ownership interests so that additional capital can be raised as additional CPMP liabilities are acquired and (4) be suitable for the borrowing against CPMP net assets or the securitization of CPMP life insurance assets. In addition, the SPE of 200 of FIG. 2, or an affiliate thereof, must be considered a worthy counterparty for the purchaser's of the CPMPs. Purchasers will be concerned about the long term creditworthiness of the promise to pay the CPMP obligations.

Referring again to FIG. 2, step 210 refers to the acquisition of data with respect to the CPMP liabilities and life insurance assets which comprise the balance sheet of the SPE. The CPMP liabilities are both dependent upon the mortality experience of the pool of CPMP purchaser's and the underlying assets upon which the CPMP's are written. With respect to mortality data, the age and risk classification and current health status of each purchaser, in a preferred embodiment is known. With respect to current health status, in a preferred embodiment each purchaser of a CPMP executes a HIPAA compliant medical record discovery request form which enables the manager of the SPE to periodically review the medical records of each purchaser. The goal of such periodic reviews is to obtain a current conditional expected lifespan for each purchaser. Any change in a given purchaser's medical condition will result in debits or credits to, in a preferred embodiment, a set of commonly used mortality tables, such as the 2001 Select Valuation Basic Tables (VBT) for Male NonSmokers. To compute the conditional life expectancy the following quantities and notation are used:
q_{t,T}=the probability of death between time t and T. conditional upon survival to time t
p_{t,T}=the probability of survival between time t and T, conditional upon survival to time t

As is commonly used, if the period of death and survival is taken to be a calendar year, the shorthand, qₜ and pₜ will be used respectively, where the second subscript, T, is implicitly understand to be equal to t+1 year. So, for example, q₅₀ is the probability that a 50 year old of a given risk class (make, nonsmoker, select) dies in the next calendar year while P₆₅ is the probability that a 65 year old of a given risk class survives in the next year. For step 210 of FIG. 2 the first substep is to acquire the qₜ for the given risk class which are available, for example, from the 2001 VBT tables. Since mortality charges are proportional to qₜ, we will assume, for sake of convenience, that the qₜ also represent the fair cost of insurance for an individual of age t in the given risk class. From the 2001 VBT tables, the q, for a 50 year old male nonsmoker is equal to:

TABLE 1
2001 VBT Mortality Rates for Male Nonsmokers Aged 50

| Age | Annual Mortality Rate |
|---|---|
| 50 | 0.13% |
| 51 | 0.17% |
| 52 | 0.20% |
| 53 | 0.23% |
| 54 | 0.28% |
| 55 | 0.33% |
| 56 | 0.38% |
| 57 | 0.45% |
| 58 | 0.51% |
| 59 | 0.59% |
| 60 | 0.66% |
| 61 | 0.75% |
| 62 | 0.84% |
| 63 | 0.96% |
| 64 | 1.10% |
| 65 | 1.25% |
| 66 | 1.38% |
| 67 | 1.50% |
| 68 | 1.62% |
| 69 | 1.76% |
| 70 | 1.98% |
| 71 | 2.25% |
| 72 | 2.56% |
| 73 | 2.91% |
| 74 | 3.24% |
| 75 | 3.63% |
| 76 | 4.00% |
| 77 | 4.41% |
| 78 | 4.89% |
| 79 | 5.45% |
| 80 | 6.09% |
| 81 | 6.8% |
| 82 | 7.6% |
| 83 | 8.4% |
| 84 | 9.3% |
| 85 | 10.3% |
| 86 | 11.4% |
| 87 | 12.6% |
| 88 | 14.0% |
| 89 | 15.4% |
| 90 | 16.9% |
| 91 | 18.5% |
| 92 | 20.0% |
| 93 | 21.5% |
| 94 | 23.2% |
| 95 | 24.9% |
| 96 | 26.7% |
| 97 | 28.4% |
| 98 | 30.1% |
| 99 | 32.0% |

As can be seen, the mortality charges increase with age at an increasing rate. As is known to one skilled in the art, there are relationships between the annual probabilities of death and the survival probabilities as follows:

$${p}_{t , T} = {\prod }_{i = t}^{i = T} ( 1 - {q}_{i} )$$

That is, the probability of surviving from time t to T is the product of one minus the probability of dying in each year from t to T. For the above “hazard rates” derived from the 2001 Select VBT table, the probability distribution for the death of a select 50 year old male nonsmoker (select in the sense that this individual qualifies for life insurance) is as follows:

TABLE 2
2001 VBT Mortality Distribution for Male Nonsmokers Aged 50

| | Probability of Death at |
|---|---|
| Age | Age |
| 50 | 0.13% |
| 51 | 0.16% |
| 52 | 0.20% |
| 53 | 0.23% |
| 54 | 0.27% |
| 55 | 0.32% |
| 56 | 0.38% |
| 57 | 0.44% |
| 58 | 0.50% |
| 59 | 0.57% |
| 60 | 0.64% |
| 61 | 0.72% |
| 62 | 0.81% |
| 63 | 0.91% |
| 64 | 1.03% |
| 65 | 1.15% |
| 66 | 1.26% |
| 67 | 1.35% |
| 68 | 1.44% |
| 69 | 1.54% |
| 70 | 1.70% |
| 71 | 1.90% |
| 72 | 2.11% |
| 73 | 2.33% |
| 74 | 2.53% |
| 75 | 2.73% |
| 76 | 2.91% |
| 77 | 3.08% |
| 78 | 3.26% |
| 79 | 3.45% |
| 80 | 3.65% |
| 81 | 3.82% |
| 82 | 3.98% |
| 83 | 4.08% |
| 84 | 4.13% |
| 85 | 4.15% |
| 86 | 4.12% |
| 87 | 4.04% |
| 88 | 3.91% |
| 89 | 3.71% |
| 90 | 3.44% |
| 91 | 3.13% |
| 92 | 2.75% |
| 93 | 2.37% |
| 94 | 2.00% |
| 95 | 1.65% |
| 96 | 1.33% |
| 97 | 1.04% |
| 98 | 0.79% |
| 99 | 0.59% |
| 100 | 0.42% |
| 101 | 0.30% |
| 102 | 0.20% |
| 103 | 0.13% |
| 104 | 0.08% |
| 105 | 0.05% |
| 106 | 0.03% |
| 107 | 0.02% |
| 108 | 0.01% |
| 109 | 0.00% |
| 110 | 0.00% |

In a preferred embodiment, a mortality distribution such as that of Table 2 can be used with a model of the liabilities to be incurred under the CPMP so that the liabilities can be simulated. Referring to FIG. 2, step 210, the liability data will comprise the (a) notional amount of risk assets to be sold at the death of each CPMP purchaser; (b) the expected dividend rate of each such risky asset class; (3) the estimated volatility of each risk asset class; (4) the strike price of each risky asset class; and (5) data linking each asset class to the mortality data of the purchaser (which purchaser's mortality distribution applies to which asset class?).

Referring again to FIG. 2, once the data for the assets (life insurance policies on purchasers) and liabilities (contingent premium mortality put cashflows) have been acquired, the assets and liabilities can be simulated in order to (1) first calculate the fair contingent premium to be charged to a prospective purchaser of a mortality put; and (b) calculate the net asset value or surplus in the SPE in present value terms.

For ease of exposition, we will assume that there are 100 actual or prospective purchasers of mortality puts and that the average purchaser is a 65 year old nonsmoking male that is able to quality for life insurance. The first step, following the data acquisition step of FIG. 2, 210, would be to simulate the process by which, beginning with 100 individuals, mortalities occur over an ensuring number of years, e.g., 45 years. For this cohort of individuals, the probability distribution for a 65 year sold select male nonsmoker is as follows (calculated using the principles discussed above):

TABLE 3
2001 VBT Mortality Distribution for Male Nonsmokers Aged 65

| | Probability of Death at |
|---|---|
| Age | Age |
| 65 | 0.380% |
| 66 | 0.525% |
| 67 | 0.684% |
| 68 | 0.854% |
| 69 | 1.034% |
| 70 | 1.209% |
| 71 | 1.375% |
| 72 | 1.532% |
| 73 | 1.685% |
| 74 | 1.965% |
| 75 | 2.268% |
| 76 | 2.595% |
| 77 | 2.953% |
| 78 | 3.343% |
| 79 | 3.769% |
| 80 | 4.075% |
| 81 | 4.307% |
| 82 | 4.531% |
| 83 | 4.743% |
| 84 | 4.951% |
| 85 | 5.048% |
| 86 | 5.095% |
| 87 | 5.075% |
| 88 | 4.972% |
| 89 | 4.732% |
| 90 | 4.451% |
| 91 | 4.043% |
| 92 | 3.560% |
| 93 | 3.069% |
| 94 | 2.590% |
| 95 | 2.138% |
| 96 | 1.723% |
| 97 | 1.341% |
| 98 | 1.020% |
| 99 | 0.757% |
| 100 | 0.547% |
| 101 | 0.384% |
| 102 | 0.256% |
| 103 | 0.167% |
| 104 | 0.105% |
| 105 | 0.064% |
| 106 | 0.038% |
| 107 | 0.022% |
| 108 | 0.012% |
| 109 | 0.006% |
| 110 | 0.003% |

In a preferred embodiment, standard uniform random variables can be used with the above probabilities (or using the force of mortality or hazard rates with the surviving cohort) to model the number of statistical deaths in each year. This process is repeated many times under a Monte Carlo Simulation. For example, the following Table 4 illustrates a single possible path of mortalities for the pool illustrated in Table 3:

TABLE 4
Single Monte Carlo Trail for Random Sequence
of Mortalities for 65 Year old MNS

| | | Pool | |
|---|---|---|---|
| Age | Beg in Pool | Deaths | Alive in Pool |
| 65 | 100 | 0 | 100 |
| 66 | 100 | 0 | 100 |
| 67 | 100 | 0 | 100 |
| 68 | 100 | 1 | 99 |
| 69 | 99 | 2 | 97 |
| 70 | 97 | 2 | 95 |
| 71 | 95 | 1 | 94 |
| 72 | 94 | 0 | 94 |
| 73 | 94 | 2 | 92 |
| 74 | 92 | 3 | 89 |
| 75 | 89 | 3 | 86 |
| 76 | 86 | 2 | 84 |
| 77 | 84 | 2 | 82 |
| 78 | 82 | 4 | 78 |
| 79 | 78 | 3 | 75 |
| 80 | 75 | 6 | 69 |
| 81 | 69 | 10 | 59 |
| 82 | 59 | 7 | 52 |
| 83 | 52 | 4 | 48 |
| 84 | 48 | 5 | 43 |
| 85 | 43 | 5 | 38 |
| 86 | 38 | 2 | 36 |
| 87 | 36 | 6 | 30 |
| 88 | 30 | 4 | 26 |
| 89 | 26 | 3 | 23 |
| 90 | 23 | 4 | 19 |
| 91 | 19 | 5 | 14 |
| 92 | 14 | 5 | 9 |
| 93 | 9 | 1 | 8 |
| 94 | 8 | 1 | 7 |
| 95 | 7 | 1 | 6 |
| 96 | 6 | 1 | 5 |
| 97 | 5 | 2 | 3 |
| 98 | 3 | 1 | 2 |
| 99 | 2 | 0 | 2 |
| 100 | 2 | 0 | 2 |
| 101 | 2 | 0 | 2 |
| 102 | 2 | 0 | 2 |
| 103 | 2 | 0 | 2 |
| 104 | 2 | 0 | 2 |
| 105 | 2 | 0 | 2 |
| 106 | 2 | 2 | 0 |
| 107 | 0 | 0 | 0 |
| 108 | 0 | 0 | 0 |
| 109 | 0 | 0 | 0 |
| 110 | 0 | 0 | 0 |

Another trial under the Monte Carlo process is displayed in the Table 5 below:

TABLE 5
Second Monte Carlo Trail for Random Sequence
of Mortalities for 65 Year old MNS

| | | Pool | |
|---|---|---|---|
| Age | Beg in Pool | Deaths | Alive in Pool |
| 65 | 100 | 0 | 100 |
| 66 | 100 | 0 | 100 |
| 67 | 100 | 2 | 98 |
| 68 | 98 | 1 | 97 |
| 69 | 97 | 0 | 97 |
| 70 | 97 | 1 | 96 |
| 71 | 96 | 2 | 94 |
| 72 | 94 | 0 | 94 |
| 73 | 94 | 1 | 93 |
| 74 | 93 | 1 | 92 |
| 75 | 92 | 2 | 90 |
| 76 | 90 | 2 | 88 |
| 77 | 88 | 2 | 86 |
| 78 | 86 | 2 | 84 |
| 79 | 84 | 4 | 80 |
| 80 | 80 | 4 | 76 |
| 81 | 76 | 7 | 69 |
| 82 | 69 | 9 | 60 |
| 83 | 60 | 3 | 57 |
| 84 | 57 | 5 | 52 |
| 85 | 52 | 5 | 47 |
| 86 | 47 | 7 | 40 |
| 87 | 40 | 6 | 34 |
| 88 | 34 | 6 | 28 |
| 89 | 28 | 1 | 27 |
| 90 | 27 | 9 | 18 |
| 91 | 18 | 2 | 16 |
| 92 | 16 | 5 | 11 |
| 93 | 11 | 0 | 11 |
| 94 | 11 | 3 | 8 |
| 95 | 8 | 1 | 7 |
| 96 | 7 | 3 | 4 |
| 97 | 4 | 0 | 4 |
| 98 | 4 | 1 | 3 |
| 99 | 3 | 0 | 3 |
| 100 | 3 | 0 | 3 |
| 101 | 3 | 2 | 1 |
| 102 | 1 | 0 | 1 |
| 103 | 1 | 1 | 0 |
| 104 | 0 | 0 | 0 |
| 105 | 0 | 0 | 0 |
| 106 | 0 | 0 | 0 |
| 107 | 0 | 0 | 0 |
| 108 | 0 | 0 | 0 |
| 109 | 0 | 0 | 0 |
| 110 | 0 | 0 | 0 |

The net cash flows of the life insurance policy assets which are purchased to collateralize, fund, or hedge the obligations on each CPMP are equal to death benefits received in each year less premiums required to be paid on the remaining surviving CPMP purchasers.

For the liability side of the balance sheet, the liabilities under the CPMP's must be simulated in accordance with the above simulation of the mortalities since each CPMP has cashflows which are contingent upon the death of the CPMP purchaser. For example, assuming that the initial premium is equal to zero (P=0) and that the out of the money contingent premium is also zero (CP_{OTM}=0) and that the in the money contingent premium has been solved for so that the discounted expected value of the CPMP is equal to zero, the liabilities can be modeled as a contingent premium mortality put, exercisable at death, using a geometric Brownian motion process as the stochastic value of the underlying risky asset or assets as follows:

$$\begin{matrix}{S}_{t} = {S}_{t - 1} exp ( ( {r}_{t} - {d}_{t} ) - \frac{{σ}^{2}}{2} + σ dz ) \\ \begin{matrix}{CPMP}_{\tilde{T}} = K - {S}_{\tilde{T}} - CP & if K > {S}_{\tilde{T}}\end{matrix} \\ \begin{matrix}{CPMP}_{\tilde{T}} = 0 , & otherwise\end{matrix}\end{matrix}$$

where
Sₜ=the value of the underlying risky asset at a time t
rₜ=the value of the riskless rate at a time t−1 to time t
dₜ=the value of the dividend rate at a time t−1 to time t
σ=the volatility of the underlying risky asset (may depend upon time as well)
\tilde{T}=the time of mortality, a random time

Thus, the total portfolio of risky assets and liabilities—the cashflows derived from owning the life insurance policies on the lives of the CPMP purchasers and having the liabilities on the CPMPs are equal to:
Cₜ=Ñₜ Dₜ−ÃₜVₜ−K−Sₜ−CP, if K>Sₜ
Cₜ=Ñₜ Dₜ−ÃₜVₜ, otherwise
Cₜ=the value of the portfolio cashflow at a time t
Ñₜ=the number of deaths at time t, a random variable
Ãₜ=the number of survivors up to time t, a random variable
Vₜ=the premium due per survivor per year at time t

Referring again to FIG. 2, step 220, the above simulation is performed many times using Monte Carlo methods. Each cashflow is discounted back to present value using the appropriate discount factor such as one based upon the length of time until the cashflow is received and the prevailing LIBOR rate to such date. The sum of these discounted cashflows, when averaged, is the discounted expected value of the value of the portfolio life insurance assets less its CPMP liabilities. The rate at which the cashflows are discounted can be increased until the discounted expected value is equal to zero. This rate would be equal to one measure of the expected internal rate of return on the portfolio.

Referring to FIG. 2, step 230, comprises the step of receiving a rating for the SPE from one of the recognized rating agencies such at Standard and Poor's, Fitch, Moody's, or A.M. Best. Such a rating may be beneficial, in a preferred embodiment, from the standpoint of providing the purchasers of CPMP's a measure of comfort that the SPE will be able to have sufficient resources at the time of each respective purchaser's mortality to pay off CPMP obligations should they be in the money.

Referring to FIG. 2, step 240, the risk management of the SPE comprises a number of substeps which include (i) frequent Monte Carlo simulation of assets and liabilities as described above given current market conditions; (ii) tracking whether a purchaser is still alive periodically; (iii) potentially hedging, in a preferred embodiment, liability risk related to the downside exposure to the SPE of the risky assets; (iv) monitoring the credit risk of the insurance carriers that issued the life insurance policies on the CPMP purchasers which are owned by the SPE; and (v) obtaining new financing for the SPE by attempting, periodically, to securitize, borrow against, or otherwise receive the present value equivalent of the future stream of cashflows to be received from the portfolio of life insurance assets owned by the SPE.

In the preceding specification, the present invention has been described with reference to specific exemplary embodiments thereof. Although many steps have been conveniently illustrated as described in a sequential manner, it will be appreciated that steps may be reordered or performed in parallel. It will further be evident that various modifications and changes may be made therewith without departing from the broader spirit and scope of the present invention as set forth in the claims that follow. The description and drawings are accordingly to be regarded in an illustrative rather than a restrictive sense.

What is claimed is:

1. A method, system, and financial product for efficient lifecycle investing, comprising the step of:
identifying suitable purchasers for a novel financial product called a contingent premium mortality put, specifying the event upon which the proceeds of the mortality put is to be paid, selecting the underling risky asset or plurality of risky assets upon which the mortality put is written, selecting a strike price for said mortality put, calculating the contingent premium for the mortality put, and obtaining the consent to purchase and purchasing on the life or lives of each respective purchaser of the mortality put a policy of life insurance.
